(19) United States
(12) Patent Application Publication
(10) Pub. No.: US 2025/0114971 A1
(43) Pub. Date: Apr. 10, 2025

(54) FORM PRESSURE CONCRETE MONITOR

(71) Applicant: SmartPour, LLC, Vancouver, WA (US)

(72) Inventors: Ashley McWatters, Vancouver, WA (US); Cory Church, Vancouver, WA (US); Greg Lucier, Raleigh, NC (US); Harley Meiers, Seattle, WA (US)

(73) Assignee: SmartPour, LLC, Vancouver, WA (US)

(21) Appl. No.: 18/910,896

(22) Filed: Oct. 9, 2024

Related U.S. Application Data
(60) Provisional application No. 63/589,012, filed on Oct. 9, 2023.

(51) Int. Cl. B28B 17/00; G01L 9/04; G01L 19/00

(52) U.S. Cl. CPC B28B 17/0081; G01L 9/04; G01L 19/0092

(57) ABSTRACT

Form pressure concrete monitor monitoring systems, assembly, and processes are disclosed. Various embodiments enhance the monitoring of pressure exerted on construction formwork assemblies using a custom-designed multi-sensor load cell and a multi-functional communication and processing unit to determine pressure from within the formwork assemblies. Further embodiments include a user-friendly interface for real-time monitoring, data analysis and retention, and record keeping.

### CROSS REFERENCE TO RELATED APPLICATIONS

This application claims the benefit of U.S. Provisional Patent Application No. 63/589,012, which was filed on Oct. 9, 2023, and entitled “FORM PRESSURE CONCRETE MONITOR.” The complete disclosure of the above application is hereby incorporated by reference for all purposes.

### FIELD OF THE INVENTION

This invention pertains to a form pressure concrete monitor system designed to address safety concerns and challenges associated with concrete pouring during construction projects, featuring a custom-designed multi-sensor load cell system, assembly and apparatus, a multi-functional data processing and transmission unit, and a user-friendly interface for real-time monitoring, data analysis, and decision-making.

### BACKGROUND

None.

### BRIEF DESCRIPTION OF THE DRAWINGS

For a better understanding of the invention, and to show how the same may be carried into effect, reference will now be made, by way of example, to the accompanying drawings, in which:

FIG. 1A is a perspective view of an illustrative construction environment, including a form pressure concrete monitoring system, assembly, and apparatus;

FIG. 1B is a perspective view of an embodiment of a custom-designed multi-sensor load cell shown in FIG. 1, illustrating its connection to the form tie;

FIG. 2 is a perspective view of an embodiment of a custom-designed multi-sensor load cell shown in FIG. 1, illustrating its cylindrical structure with an annular aperture;

FIG. 3A is an exploded view of the load cell of FIG. 2, showing the inside of the seal plate;

FIG. 3B is an exploded view of the load cell of FIG. 2, showing the inside of the multi-faceted bearing plate;

FIG. 3C is a bottom view of the load bearing plate of FIG. 3B, illustrating an exemplary the load cell internal components;

FIG. 4 is a cross-sectional view of the load cell of FIG. 2, illustrating internal structure, without depicting internal components;

FIG. 5A is a perspective view of the multi-faceted bearing plate of the load cell of FIG. 2 in an uncompressed state;

FIG. 5B is a perspective view of the multi-faceted bearing plate of the load cell of FIG. 2 showing displacement of the plate due to applied pressure;

FIG. 6 is a perspective view of the load cell showing the pressure distribution across the multi-faceted bearing plate under an applied load;

FIG. 7 is a method of monitoring formwork pressure during a concrete pour using the form pressure concrete monitoring system, assembly, and apparatus.

FIG. 8 is a diagram illustrating an exemplary database topology used for the form pressure concrete monitoring system, assembly, and apparatus.

FIG. 9 is a schematic diagram of various components of an illustrative data processing system; and

FIG. 10 is a schematic representation of an illustrative distributed data processing system.

### DETAILED DESCRIPTION

The need for a form pressure concrete monitor arises from the critical importance of ensuring the safety, precision, and efficiency of concrete pouring processes in construction projects. Traditional methods of monitoring form pressure have proven inadequate, leading to various challenges and potential risks. Without an advanced, reusable form pressure concrete monitor, construction professionals lack reliable means of accurately gauging and controlling the immense forces exerted by concrete during placement.

A significant concern is the potential danger posed to workers caused by flying bolts and other hazards resulting from formwork blowouts during the pouring process. Without reliable means of monitoring and controlling form pressure, the safety of on-site personnel may be compromised, and construction sites become susceptible to accidents and injuries. Furthermore, the significant financial implications of costly and time-consuming formwork blowouts highlight the critical role of a form pressure concrete monitor. These blowouts cause significant project delays, as well as budget overruns and wasted resources.

The numerous challenges and safety concerns persist today. Conventional methods and tools for monitoring concrete form pressure have exhibited notable shortcomings, prompting the need for innovative, calibrated, and reusable alternatives.

Conventional form pressure monitoring systems often lack calibration, reducing their precision and accuracy. Conventional systems are typically single-use and costly, as they must be immersed within the formwork and concrete to take accurate measurements, rendering them impractical and costly for repeated use across various construction projects. In contrast, the various form pressure concrete monitoring systems disclosed herein break away from this restrictive pattern, ensuring high precision in measuring compressive forces without needing to be embedded within the formwork, allowing for accurate and controlled management of concrete placement during construction projects.

Existing tools and equipment for monitoring form pressure often fail to meet the specific demands of concrete pouring. Some solutions use single-use monitors that are not specifically designed for the complexities of form pressure, and these are typically tied to the form or formwork itself to measure the pressure exerted by the concrete during the pour. The concrete form pressure monitor described here, however, is attached to the form tie and employs a custom-designed load cell assembly, engineered to precisely measure forces, weight, and pressure from the expansion of form ties. This departure from conventional practices marks a significant advancement in form pressure monitoring.

Disclosed herein is a novel form pressure concrete monitor addressing the complex challenges and safety concerns inherent in concrete pouring during construction projects. The present disclosure details the form pressure concrete monitor, its structural intricacies, operational processes, software components, and potential applications.

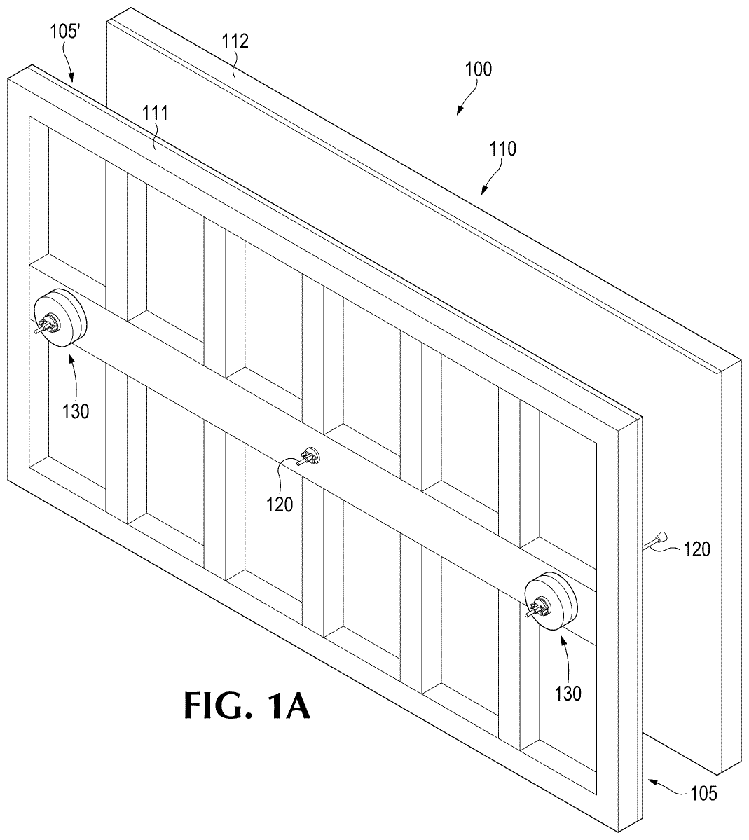

Referring to FIGS. 1A and 1B, FIG. 1A illustrates a perspective view of an illustrative construction environment, including a form pressure concrete monitoring system, assembly, and apparatus. FIG. 1B provides a closer view of the system without the formwork, specifically illustrating an embodiment of a custom-designed multi-sensor load cell and its connection to the form tie.

Referring to FIG. 1A, an illustrative construction environment 100 is depicted, showing the placement and operation of a form pressure concrete monitoring system, assembly, and apparatus 105. In this environment, the monitoring system, assembly, and apparatus 105, including a custom-designed multi-sensor load cell 130 as further described below, is configured to continuously monitor the pressure exerted on formwork assembly 110 from within the formwork assembly 110 itself. The formwork 110 includes two opposing panels, a first formwork panel 111 and a second formwork panel 112, which are secured by one or more concrete form ties 120.

While FIG. 1A illustrates formwork with two opposing panels 111 and 112, it will be appreciated that the monitoring system, assembly, and apparatus 105 may also be utilized in other formwork configurations, such as single-sided formwork having a single panel, curved formwork, multi-faceted formwork, and more. In such embodiments, the concrete form ties 120 can be adapted or arranged accordingly to accommodate the load cell 130, enabling continuous monitoring of pressure exerted on various formwork structures and enabling transfer of compression and tension forces from the formwork 110 to the load cell 130 mechanically. Furthermore, the monitoring system 105, including the load cell 130, may be utilized with various shapes, sizes, and configurations of form ties, and the invention is not limited to any specific tie design.

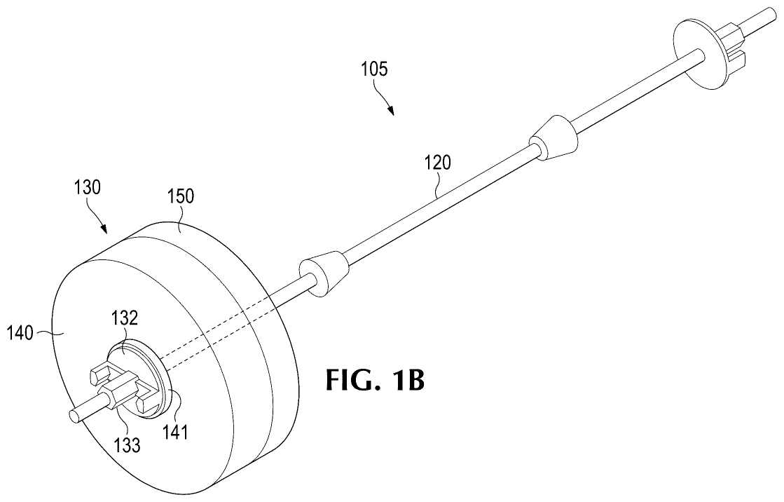

As shown in FIGS. 1 and 2, the load cell 130 is securely attached to the form tie 120, facilitating continuous measurement of the pressure exerted by the concrete on the formwork 110. In addition to its pressure sensing functionality, the monitoring system, assembly, and apparatus 105 may be enhanced further by including additional relevant sensors such as temperature, humidity, moisture, maturity sensors, and more. The load cell 130 features a central, annular aperture 131 that traverses the entirety of the load cell 130 through which the form tie 120 extends. This configuration allows for secure attachment of the load cell 130 to the form tie 120 to ensure accurate pressure measurement and monitoring of pressure exerted on the formwork assembly 110. This aperture 131 is of sufficient size to allow the load cell 130 to accommodate various form tie 120 shapes.

Each load cell 130 may be secured to a form tie 120 using appropriate fastening means. In embodiments, the load cell 130 is secured by sliding it onto the form tie 120, followed by placing a load-bearing compression-resistant metal washer 132 over the load cell 130, and fastening it with a nut 133. Alternative fastening methods such as locking nuts, rivet nuts, flange nuts, wedge locking nuts, hydraulic tensioners, and more may be employed to secure the load cell 130 to the form tie 120.

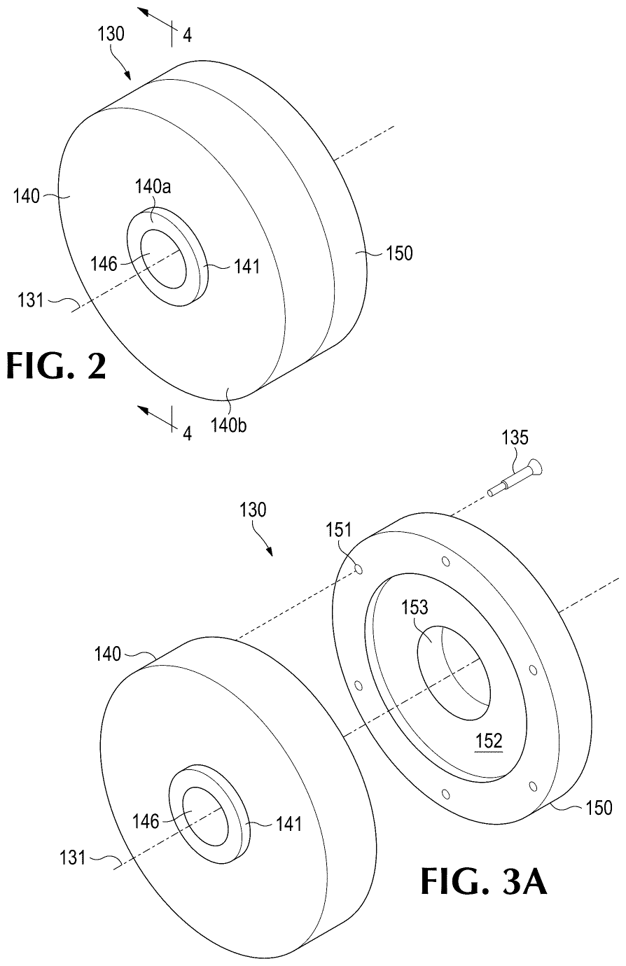

Integrated into or connected to the load cell 130 is a multi-functional communication and processing unit 136 that facilitates additional functionalities, as described later with respect to FIG. 3C. In certain embodiments, the communication and processing unit 136 may be positioned externally, outside of the load cell 130, and connected to it through any appropriate cable, conduit, or wireless interface to ensure seamless communication with the load cell 130. This arrangement allows flexibility in the placement of the communication and processing unit 136, enabling more convenient access for maintenance or data transmission, while ensuring the load cell 130 remains securely attached to the form tie 120 for accurate measurement and monitoring of the concrete pressure exerted on the formwork 110. The design of the load cell 130 allows for adaptation to various form tie shapes, ensuring compatibility with a wide range of form tie configurations. In embodiments, the communication and processing unit 136 is operatively connected to the load cell 130.

Referring to FIG. 2, the custom-designed multi-sensor load cell 130 is shown, illustrating its cylindrical structure with an annular aperture 131, through which a the form tie 120 traverse. The load cell 130 is primarily comprised of two main structural components forming its enclosure: a multi-faceted bearing plate 140 and a seal plate 150, which together provide both protection and functional support to the internal components of the load cell 130.

The multi-faceted bearing plate 140 includes a load-bearing surface 140a and a displacement surface 140b. The load-bearing surface 140a is configured to receive and distribute the compressive forces exerted by the form tie 120, ensuring that the pressure from the concrete during the pouring process is accurately transmitted to the internal sensors, as discussed below. The displacement surface 140b, serves to manage the displacement of the load cell 130 under stress, allowing for a controlled response to the applied pressure, which will be translated into measurable signals by the multi-functional communication and processing unit 136. In embodiments, the displacement surface 140b is less than 1 inch in thickness.

The seal plate 150, positioned opposite the multi-faceted bearing plate 140, acts as a closure to protect the internal components from external environmental factors, such as moisture, debris, concrete, and more. In this configuration, the seal plate 150 ensures that the internal sensors and electronic components remain intact and functional during and after the concrete pouring process. Depending on the embodiments, either the seal plate 150 or bearing plate 140 may be oriented to face the formwork 110 and come into contact with the form tie 120.

In embodiments, the entirety of the load cell 130, including the multi-faceted bearing plate 140 and the seal plate 150, is made of aluminum. In further embodiments, the load cell 130 is fabricated from 6061 aluminum, a material suitable due to its strength, corrosion resistance, and suitability for machining. In further embodiments, the material used is 6061-T6 aluminum, which has been treated to enhance its mechanical properties, providing increased yield strength and tensile strength. These properties make the material ideal for load-bearing applications, such as the form pressure monitoring system, assembly, and apparatus 105, where both lightweight characteristics and high strength are necessary.

In embodiments, each plate—both the multi-faceted bearing plate 140 and the seal plate 150—is composed of a single, continuous piece of material with no breaks or seams, ensuring structural integrity and uniform distribution of force across the load cell 130. In other embodiments, the multi-faceted bearing plate 140 is formed by the load-bearing surface 140a and the raised annular ring 141 as separate components that are welded together, creating a unified structure capable of withstanding significant mechanical loads during operation.

The 6061-T6 aluminum used in some embodiments exhibits several mechanical properties that illustrate its suitability for this application. Illustrative properties include a yield strength of approximately 2.75e+08 N/m² and a tensile strength of around 3.1e+08 N/m². These properties ensure that the load cell can withstand the compressive forces typically encountered in concrete monitoring without experiencing undue deformation or failure. In terms of volumetric properties, an example configuration of the load cell made from 6061-T6 aluminum might exhibit a mass of approximately 0.721045 kg, which highlights the material's lightweight nature while maintaining the necessary strength for use in high-stress environments, with a volume of around 0.000267054 m³, and a density of 2,700 kg/m³.

It will be understood that the characteristics and properties of the aluminum described herein are illustrative, and the invention is not limited to this specific material or its properties. Other materials with similar or enhanced properties may also be used. For instance, other aluminums, titanium alloys, high-strength steels, and more may be employed. This is based on the desired use to achieve greater durability or flexibility in handling displacement, without sacrificing resistance to deformation under heavy loads. These materials offer a balance between strength, flexibility, and machinability, ensuring that the load cell design remains adaptable to a variety of construction environments and application requirements.

Referring to FIGS. 3A to 3C, several exploded views of the load cell 130 are shown, illustrating its internal structure and components. The bearing plate 140 is outfitted with a raised annular ring 141 that surrounds the central aperture 131. This raised annular ring 141 provides structural reinforcement, ensuring that the bearing plate 140 can withstand high compressive forces without significant deformation, if any. The bearing plate 140 is equipped with several blind holes 144, which may or may not be threaded, and the seal plate 150 is equipped with corresponding through countersunk or counterbored holes 151, which in embodiments may be threaded, that align during assembly. Flush-mount fasteners 135 are inserted through the through countersunk holes 151 and into the blind holes 144, securely fastening the plates 140, 150 together and creating a tight seal between the components, ensuring structural integrity and protection for the internal cavity 134 of the load cell 130.

In embodiments, within the load cell's 130 enclosure, the internal cavity 134, houses various electronic components used for its operation, including one or more compression sensors 160 and one or more tension sensors 161. In further embodiments, the load cell 130 includes two compression 160 sensors and two tensions 161 sensors that are arranged in Wheatstone bridge configuration. In embodiments, additional sensors are users (e.g. four, six, eight, or more total sensors). In embodiments, other configurations may be utilized including, but not limited to, full-bridge configuration, half-bridge configuration, quarter-bridge configuration, and more.

In embodiments, the load cell 130 is configured in a full-bridge configuration wherein four sensors are placed symmetrically around the load cell 130 (e.g., at 0°, 90°, 180°, and 270° positions), with two in tension 161 and two in compression 160 as the load deforms or displaces the load cell 130. This allows for temperature compensation and ensures that the load cell is sensitive to vertical or axial forces, even if the load is slightly off-center. For example, if the load is applied vertically, strain gauges 160 placed on the sides of the load cell 130 would measure compression, while those on the strain gauges 161 would measure tension. The reverse may be true depending on the direction of the load.

In embodiments, the tension gauges 161 and the compression gauges 160 of the load cell 130 are configured in separate circuits to detect force applied to the load cell 130. The tension gauges 161 are positioned to measure the tensile strain on portions of the load cell experiencing stretching forces, while the compression gauges 160 are positioned to measure compressive strain on portions of the load cell 130 experiencing compressive forces. Each set of gauges 160, 161, in embodiments, is electrically isolated and connected to independent Wheatstone bridge circuits, allowing for separate and precise detection of tensile and compressive forces.

For those embodiments, the outputs from the tension and compression bridge circuits are combined using a signal processing unit 162 or microcontroller. The system can sum, filter, or otherwise process the signals from each bridge circuit to determine the net force acting on the load cell 130. This modular approach allows for flexibility and precision, as each type of strain is measured independently, providing high accuracy in detecting forces applied in both tensile and compressive directions. The system can also compensate for temperature fluctuations and non-uniform force distribution, which may otherwise affect the accuracy of a single circuit configuration, in some cases.

In yet other embodiments, the tension and compression gauges 160, 161, may be arranged in a hybrid full-bridge configuration, with the tension gauges 161 placed in one leg of the Wheatstone bridge and the compression gauges 160 placed in the opposite leg. This configuration allows the differential between tensile and compressive forces to be measured directly, outputting a single signal representing the total applied force. The system compensates for off-axis loading and thermal variations, enhancing the overall sensitivity and reliability of the force measurements.

The internal cavity 134, in embodiments, houses a signal processing unit 162, analog to digital converter 163, a control unit 164, a wireless communication unit 165, a power supply 166 and other related components, collectively referred to as multi-functional communication and processing unit 136. In embodiments, the communication and processing unit or dongle 136 may be externally connected to the load cell 130 through an external interface, where a dedicated port is integrated into the load cell 130. In embodiment, the port is located on the side of the bearing plate 140. This configuration facilitates the transmission of force measurements to the external communication and processing unit 136. The connection between the load cell 130 and the unit 136 can be established using either a wired or wireless communication method, depending on the specific implementation.

The compression sensors 160 and the tension sensors 161 are strategically positioned within the cavity to directly measure the forces exerted on the bearing plate 140. When the load-bearing surface 140a receives compressive force, the resulting displacement is detected by the sensors 160, 161 and processed by the communication and processing unit 136 which converts the physical strain into an electrical signal.

In embodiments, the compression sensors 160 and tension sensors 161 are used to measure strain, which represents the deformation or displacement of the bearing plate 140 when subjected to forces such as the expansion of portions of the form tie 120 due to the expansion of the formwork panels 111 and 112. These sensors 160, 161 are capable of detecting forces such as tension, compression, bending, or twisting that occur during the expansion or movement of the formwork assembly 110. In further embodiments, the compression sensors 160 consist of thin metallic materials arranged on opposite ends and placed in close proximity to the hollow ring cavity 146, bonded to the interior surface of the depressed ring 143 of the bearing plate 140.

While the size of the sensors 160, 161, as shown may be relatively small, the sensors 160, 161, may be of any size up to covering the entire depressed area 143 of the bearing plate 140. In embodiments, a metal wire mesh is integrated into one or more sensors 160, 161, where it functions as a conductive element that deforms under applied stress or pressure. The deformation of the wire mesh results in measurable changes in electrical properties, such as resistance or capacitance, enabling the sensors to detect and quantify mechanical forces with high precision. The wire mesh may also be integrated into the depressed area 143 and covering the entirety of the depressed area's 143 surface.

The sensors 160, 161 measures the amount of deformation per unit length, often expressed as a ratio, such as microstrain. Strain can occur if the bearing plate 140 is subjected to tension, stretching, and/or compression. The sensors 160, 161 can also be used to measure stress by relating strain to stress through material properties, using principles such as Hooke's Law for materials operating within their elastic range.

When a force is applied to the load-bearing surface 140a, the bearing plate 140 undergoes slight displacement or deformation, causing the compression sensors 160 to stretch or compress along with the internal surface of the bearing plate 140. This deformation induces a measurable change in the electrical resistance of the sensors 160, where the magnitude of resistance change is directly proportional to the strain exerted on the load-bearing surface 140a. The strain detected by the sensors allows for accurate real-time monitoring of the forces acting on the load cell 130.

In embodiments, the compression sensors 160 and tensions sensors 161 are arranged to precisely capture deformation from both compression and tensile forces. In embodiments, the compression sensors 160 are positioned on opposite side on the depressed ring 143 near the hollow ring cavity 146, which experience the most significant strain during operation. The tension sensors 161 are positioned on opposite side on the depressed ring 143, rotated 90° from the compression sensors 160, further away from the hollow ring cavity 146, in embodiments, which experiences the least strain during operation. As the bearing plate 140 deforms or displaces under load, the strain is measured through the sensors 160, and communication and processing unit 136 captures this data as electrical signals, which can then be processed and converted into force measurements.

These sensors 160, 161 may be configured as part of a Wheatstone bridge circuit, maximizing sensitivity by placing sensors at key deformation points-measuring both compressive and tensile strains on different location on the bearing plate 140. This arrangement provides precise monitoring of compressive forces exerted on the load-bearing surface 140a, as well as any bending or twisting forces experienced by the bearing plate 140.

The compression sensors 160 and tension sensors 161 are strategically positioned within the internal cavity 134 to directly measure the forces exerted on the bearing plate 140. When the load-bearing surface 140a receives a compressive force, the resulting displacement of the load bearing surface 140a and displacement surface 140b is detected by both the compression sensors 160 and tension sensors 161, which transmit the information to the communication and processing unit 136. This unit 136 processes the physical strain and converts it into an electrical signal for further analysis.

After the compression sensors 160 and tension sensors 161 measure the strain on the bearing plate 140, the collected data is processed and transmitted through a series of components housed within the internal cavity 134, which are part of the communication and processing unit 136. Once the compression sensors 160 and tension sensors 161 detect strain, the raw electrical signals generated from the deformation are sent to the signal processing unit 162 to be filtered, amplified, and conditioned for further analysis. The signal processing unit 162 removes any noise or interference, ensuring the signals accurately reflect the strain exerted on the load-bearing surface 140a and displacement surface 140b. It may also normalize or stabilize the signal to account for temperature variations or other environmental factors.

After the signals are processed, the analog to digital converter 163 takes these conditioned analog signals and converts them into digital data. This conversion is necessary because digital data can be more easily processed, stored, and transmitted by the subsequent electronic systems. The ADC 163 quantizes the continuous analog signal into discrete values, ensuring the strain data is accurately represented in a format suitable for digital processing.

Once the strain data is digitized, it is sent to the control unit 164. The control unit 164, in embodiments, is responsible for managing and coordinating the overall operation of the communication and processing unit 136. In embodiments, it applies algorithms to calculate the actual force, pressure, or stress being exerted on the bearing plate 140, based on the digital strain data received from the ADC 163. The control unit may also perform error-checking and validation of the data to ensure it is within expected ranges, or flag any anomalies for further inspection.

After the control unit 164 processes the data, the results, such as the measured force or strain, are transmitted to an external device or monitoring system via the wireless communication unit 165. This unit allows for real-time data transmission, enabling remote monitoring of the system. The wireless communication unit uses protocols such as Wi-Fi, BLUETOOTH®, LTE, or another low-power wireless standard to send data from the load cell to a central hub or mobile device where it can be analyzed further.

The communication and processing unit 136 is powered by the power supply 166, which may consist of batteries, a rechargeable power source, or another energy-harvesting method. The power supply 166 ensures continuous operation of the signal processing unit 162, analog to digital converter 163, control unit 164, and wireless communication unit 165. Depending on the application, the power supply 166 may be optimized for low power consumption, especially if the system is meant to operate for extended periods in remote locations without easy access to recharging or replacement.

As described above, the load cell assembly 130 is configured to detect the forces exerted on the formwork assembly 110 through a variety of strain gauges 160, 161 using one of the many configurations disclosed here. The load cell 130 assembly, in embodiments, is attached to a form tie 120, enabling the system to accurately measure both compressive and tensile forces acting on the formwork, providing monitoring of forces transferred from the formwork during the concrete pour.

In embodiments, the system, assembly, and apparatus 105 further comprises an accelerometer, which works together with the sensors 160, 161, to provide real-time data on the structural integrity of the formwork during construction and concrete pouring. The accelerometer is configured to detect external vibrations that may affect the formwork assembly 110. These vibrations can be caused by various construction activities, including, but not limited to, the use of devices inserted into fresh plastic concrete, external vibrators mounted on the formwork assembly 110, equipment operating near the formwork assembly 110, vibration caused by the pouring of concrete into the formwork assembly 110, vibration caused by the expansion of the formwork assembly 110, vibration as a result of pressure applied to the formwork assembly 110, and more. The accelerometer provides vibration data that may influence the pressure exerted on the formwork assembly 110, ensuring the system 105 can dynamically adjust to changes during the concrete pouring process.

The communication and processing unit 136, in embodiments, is operatively connected to both the load cell assembly 130 and the accelerometer, and it is configured to receive outputs from the pressure sensors 160, 161 and vibration data from the accelerometer. Upon receiving this data, the communication and processing unit 136 analyzes the outputs to determine the forces exerted on the formwork 110 and identifies any vibration events that may impact those forces. For example, vibrations from the formwork assembly 110, such as through the expansion of the formwork 110, can introduce variations in the pressure on the formwork 110, which the processor will detect and compensate for by adjusting the detected forces exerted on the formwork based on the vibration data. This adjustment, in embodiments, ensures that the system can provide accurate readings of the forces affecting the formwork 110, even in the presence of external vibrations, such as external vibrators mounted to the exterior of the formwork 110. The communication and processing unit 136 compares the compensated forces to a safety threshold, which in embodiments depends on the pressure ratings of the mounting surface such as form ties 120, to ensure that the pressure on the formwork 110 remains within safe operational limits. The specified range or safe operational limits is, in embodiments, specified as any percentage of the pressure ratings, such as 10%, 20%, and so on. If the forces exceed the threshold or the specified operational limits, the system 105, in embodiments, generates signals to alert construction personnel.

The system 105, in embodiments, is also capable of generating signals to indicate the occurrence of vibration events and whether the adjusted forces fall within the specified range of the predefined threshold. These signals provide real-time feedback to construction teams, ensuring that they are aware of any potential issues with the formwork's structural integrity. Additionally, the communication and processing unit 136, in embodiments, is configured to transmit the analyzed outputs, identified vibration events, and signals to a user device, a server, a cloud, or other data structure for remote monitoring, further processing, storing, and more.

Further enhancing the system's functionality, the communication and processing unit 136, in embodiments, is equipped with a filtering mechanism to filter out low-magnitude vibrations that do not significantly, or negligibly, affect the formwork 110. This ensures that the system focuses on relevant vibration events without overreacting to minor disturbances. Additionally, the load cell assembly 130, in embodiments, includes a temperature sensor, which monitors environmental conditions such as temperature. The communication and processing unit 136 adjusts the measured forces based on any changes in temperature, ensuring that fluctuations in environmental conditions are accounted for in addition to fluctuations in vibration.

Similarly, a method for monitoring concrete formwork pressure is also disclosed. In embodiments, the method involves detecting forces exerted on the formwork 110 using the load cell assembly 130, detecting vibrations using the accelerometer, and receiving data from these components via the communication and processing unit 136. The communication and processing unit 136 then analyzes the data to determine exerted forces and identifies vibration events affecting pressure on the formwork 110. The method, in embodiments, further includes adjusting the determined forces, comparing the adjusted forces to a predefined threshold, and generating signals based on whether the forces are within a safe, specified range (e.g. 10% of pressure ratings of the mounting surface of the load cell 130). The signals and analyzed data are then transmitted to and/or displayed on a device, a cloud server, a storage unit, and more.

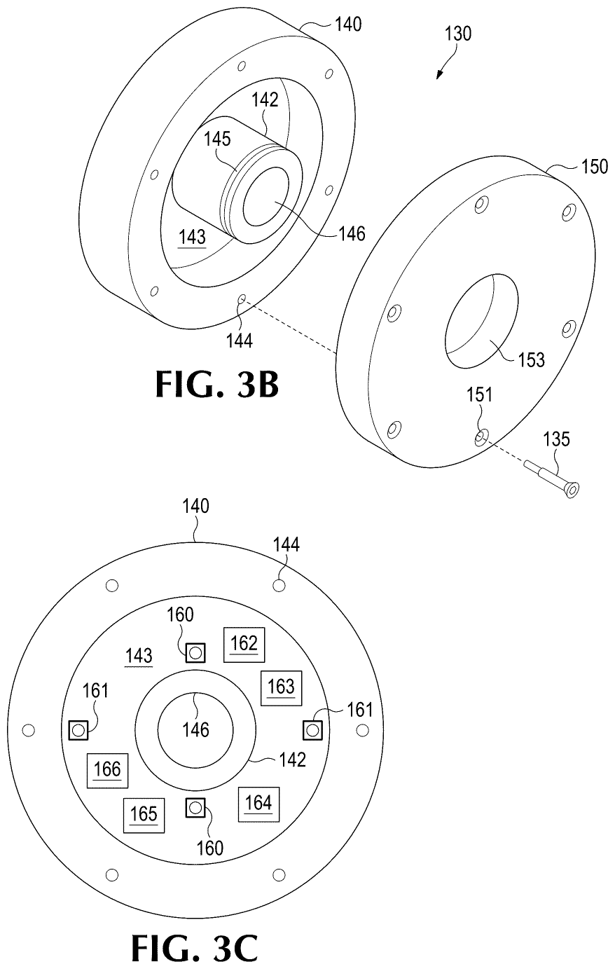

Referring to FIG. 4, a cross-sectional view of the load cell 130 is shown, providing further detail of the internal structure, excluding internal components. The load cell 130 includes a centrally located annular aperture 131, which accommodates the passage of the form tie 120 through the load cell 130. Surrounding the aperture is a hollow ring cavity 146, which is defined by the raised annular ring 141 on the outer portion of the load cell 130 and the annular ring 142 on the inside of the load cell 130.

The bearing plate 140 forms the upper portion of the load cell 130 and, together with the seal plate 150, encloses the internal cavity 134. This cavity 134 may be used to house various components (not shown in this view), such as sensors and processing units. The internal cavity 134 extends around the hollow ring cavity 146, with dimensions of approximately 1.1 inches, in embodiments. The cavity 134 is formed by the depressed area 143 of the bearing plate 140 and the corresponding depressed area 152 of the seal plate 150.

The load cell 130 is secured together using flush-mount fasteners 135, which pass into the blind holes 144 in the bearing plate 140 and through the through countersunk holes 151 in the seal plate 150. Between the two plates 140, 150, to ensure a tight seal and protect from environmental elements, an annular groove 145 is provided on the outer portion of the hollow ring cavity 146. This groove is designed to house a reversed O-ring 147, which seals the connection between the bearing plate 140 and the seal plate 150, while still allowing the form tie 120 to pass through the center of the load cell 130. This configuration ensures that the load cell 130 remains tightly sealed and structurally sound during operation, while also accommodating the necessary components and providing an efficient passage for form ties.

Referring to FIGS. 2 through 4, the figures show several views of the multi-faceted bearing plate 140 and seal plate 150 of the load cell 130, illustrating several components. The bearing plate 140 is shown with its load-bearing surface 140a on top, which is designed to make contact with external forces such as the form tie 120. The underside of the plate 140 features the displacement surface 140b, which displaces or deforms in response to applied forces. The raised annular ring 141 and the annular ring 142 define the hollow ring cavity 146 and encapsulate the depressed ring 143 on one side.

Blind holes 144 are evenly spaced around the plate 140, allowing for secure attachment of the seal plate 150 using flush-mount or countersunk fasteners 135. The annular groove 145 is positioned on the outer edge of the hollow ring cavity 146 and is designed to house the reversed O-ring 147, which seals the connection between the bearing plate 140 and the seal plate 150, ensuring the internal cavity remains protected from external elements. The O-ring 147 may be used of a hard, extrusion-resistant material such as nylon, Hytrel, high durometer nitrile, fluorinated ethylene propylene (FEP), perfluoroelastomer (FKM), nitrile butadiene rubber (NBR), polytetrafluoroethylene (PTFE), hydrogenated nitrile butadiene rubber (HNBR), and more.

The seal plate 150 includes several through countersunk holes 151, which extend entirely through the plate 150. These holes are designed to receive the flush-mount fasteners 135, securing the seal plate 150 to the bearing plate 140. The depressed ring 152 is positioned around the perimeter of the seal plate 150, with a diameter closely matching the corresponding depressed ring 143 on the bearing plate 140. At the center of the plate 150, the ring recess 153 is designed to receive at least part of the annular ring 142, which forms part of the hollow ring cavity 146. The ring recess 153 works in conjunction with the reversed O-ring 147, creating a tight seal with the annular ring 142, ensuring that the load cell 130 is properly sealed and components within it are protected. This arrangement prevents external contaminants from entering the internal cavity 134 and maintains the integrity of the load cell 130 during operation.

In embodiments, the diameter of the ring recess 153 on the seal plate 150 is marginally larger than the exterior diameter of the hollow ring cavity 146, allowing for a snug fit, while giving room for the ring 146 to move. In further embodiments, the depths of the depressed rings 152 and 143 differ, with the depressed ring 143 being deeper. This difference allows for proper spacing between the two plates, accommodating internal components and allowing for displacements. In yet further embodiments, the through countersunk holes 151 are marginally larger than the blind holes 144, allowing fasteners 135 to be inserted and countersunk properly.

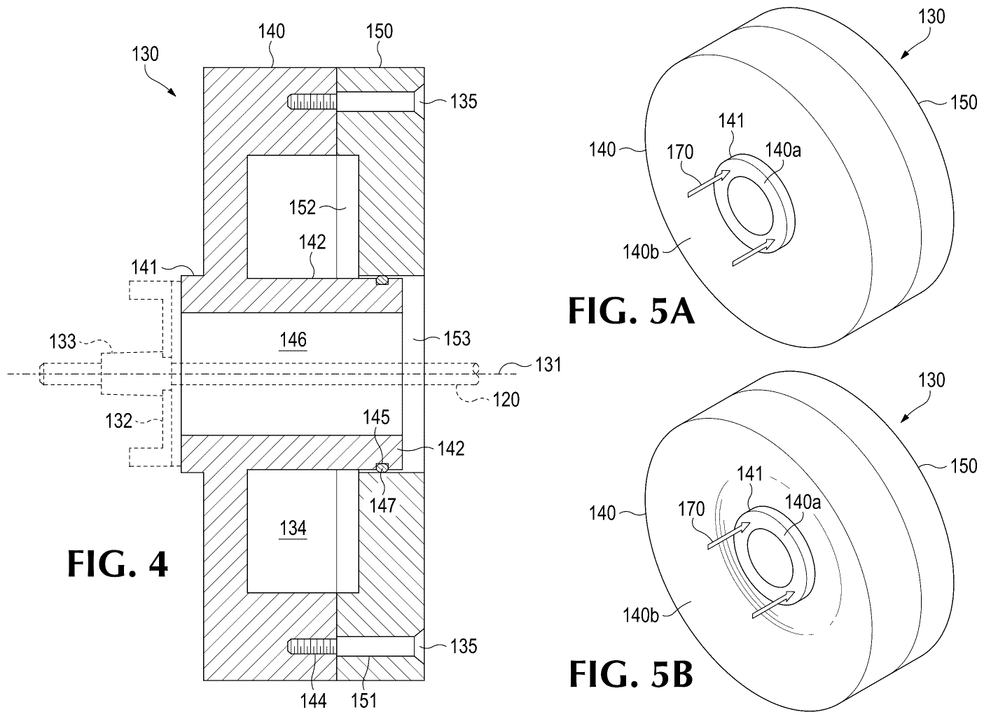

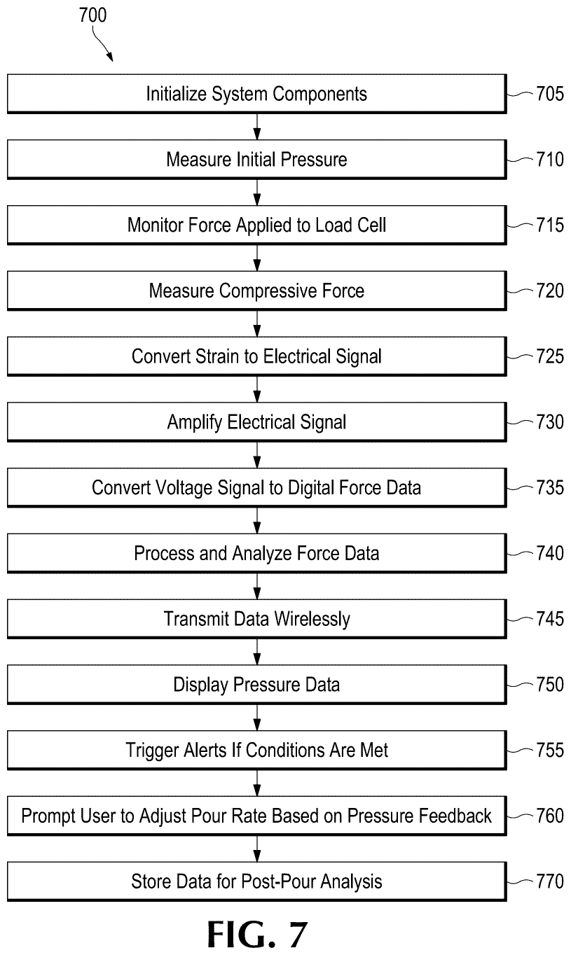

Referring to FIGS. 5A and 5B, in FIG. 7A, the load cell 130, including the bearing plate 140 and load-bearing surface 140a, is depicted in an uncompressed state, with pressure application indicators 170 demonstrating where the forces are applied. In FIG. 5B, as the force is applied, the bearing plate 140 undergoes displacement as pressure on the load-bearing surface 140a increases. The load cell 130 undergoes deformation proportional to the applied force and returns to its original shape once the force is removed as shown by the movement of the load-bearing surface 140a and displacements surface 140b closer to the raised annular ring 141. In embodiments, the load cell 130 exhibits the same mechanical properties in all directions, ensuring uniform performance regardless of how the force is applied. In embodiments, the load cell 130 is designed to accommodate a displacement of 6.871e-01 mm. In embodiments, the load cell 130 can withstand stresses of 5.744e+08 N/m², while remaining within the elastic region, ensuring it returns to its original shape after load removal.

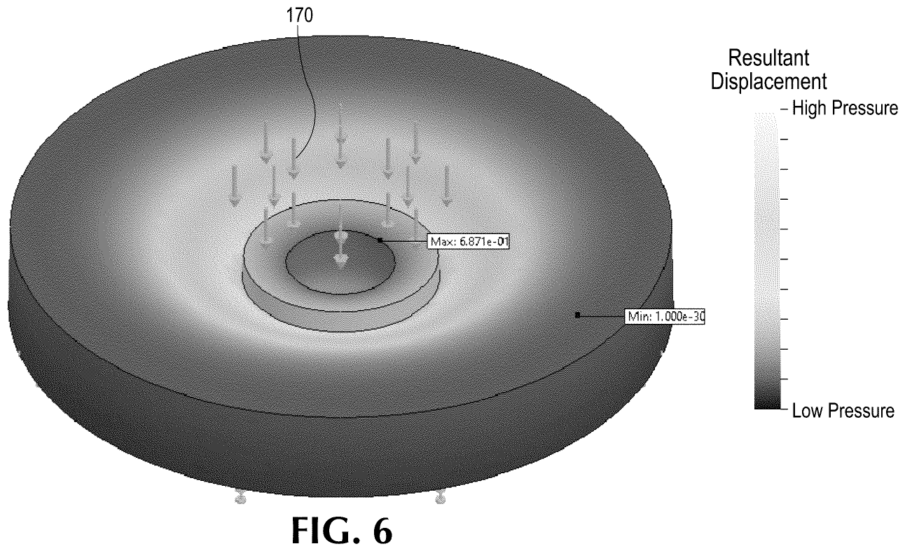

FIG. 6 illustrates an exemplary pressure distribution across the load cell 130, focusing on the bearing plate 140 and load-bearing surface 140a. The force application indicators 170 show how the force is concentrated and distributed across the surface. The bar on the right side of the figure displays the resultant displacement. The highest displacement, depicted in dark grey, occurs near the center of the load-bearing surface 140a, where the force is most concentrated. As the distance from the center increases, both pressure and displacement decrease, transitioning into unshaded areas that represent minimal displacement. These unshaded regions typically appear closer to the outer edges, where the load cell experiences the least deformation, if any. This distribution illustrates the strategic placement of the sensors 160 and 161, as previously discussed, to capture pressure variations effectively.

FIG. 7 illustrates a method for monitoring formwork pressure 700 using the form pressure concrete monitoring system, assembly, and apparatus 105.

At step 705, the system 105 is powered on, activating the power supply 166 for the load cell 130 and associated electronic components, including the communication and processing unit 136. During this step, calibration is performed to establish an initial baseline or zero-point, ensuring accurate force measurement. In embodiments, the baseline is calculated and determined during the calibration process. In further embodiments, the baseline incorporates user input, such as the type of concrete and other relevant data, to enhance calibration accuracy. This calibration sets the tare value before any load is applied to the formwork assembly 110, accounting for any initial load or imperfections in the setup. The system is also initialized to manage the transmission of force data collected from the sensors 160, 161 of the load cell 130, packaging this data into a raw data packet that may include fields for the device name, sensor readings, and relevant metadata. Additionally, the system verifies that the load cell 130 is correctly communicating with the wireless communication unit 165, ensuring smooth data transmission for further processing and monitoring.

The calibration process for the system 105 begins with the initial setup of the load cell 130 and its associated components, including the compression sensor 160 and tension sensor 161. Before any load is applied, the system 105 is zeroed out through a baseline calibration, which involves setting a tare value to eliminate any pre-existing forces or environmental factors that might affect the readings. In some embodiments, the system 105 allows for operator input regarding the type of concrete and other relevant data, ensuring the baseline is accurately calibrated to reflect real-world conditions.

Once the baseline is established, the system 105 proceeds to load increment calibration, where known weights are applied at regular intervals. These intervals may be set at 10,000-pound increments but may vary based on the specific requirements. During each interval, the system records the response of the sensors to ensure that the load cell's 130 output is linear and consistent across the entire range of applied forces.

In further embodiments, pressure calibration is incorporated into the process, taking into account the rated capacity of the form ties 120. This ensures that the system 105 not only measures weight but also accurately captures the pressure exerted. The calibration process continues with the application of a calibration constant, which is used to adjust raw data from the sensors 160, 161 to produce meaningful force and pressure readings in standardized units, such as pounds or Newtons.

In embodiments, to calculate the calibration factor for a load cell 130, the process begins by averaging sensor readings at specific applied weights, e.g., 4000, 8000, 16000 units. For each weight, multiple sensor readings are taken, and their average is calculated to reduce noise and improve accuracy. These averaged values are then plotted on an XY graph, where the X-axis represents the applied weights, and the Y-axis represents the sensor readings. The slope of the line of best fit is determined, for example, by determining the change in sensor readings over the change in applied weights. The calibration factor is obtained by taking the inverse of the slope. This calibration factor is then applied to convert future sensor outputs into accurate force measurements during the operation of the load cell system. This process ensures that the system provides reliable and precise data for real-time force monitoring.

At step 710, as the concrete pour begins, the system 105 detects the initial force applied to the formwork assembly 110 via the bearing plate 140. This initial pressure may serve as a reference point before any significant force accumulates. The system 105 is designed to gather raw data from the load cell 130, which is subsequently processed to calculate various user-readable data, including force and temperature. Prior to calculating any weight or force, the system first zeroes out any baseline readings from the load cell 130 by setting a tare value, ensuring accuracy. The raw data from the load cell 130 may be collected over multiple samples to minimize noise and fluctuations, resulting in a more stable and reliable reading. This raw data is then converted into a relevant measurement, such as force measurements, by applying a calibration constant that adjusts for the specific characteristics of the load cell 130 being used.

At step 715, the compression sensor 160 and tension sensor 161 integrated into the load cell 130 continuously monitor the strain and forces exerted on the system 105. These sensors 160, 161 are strategically mounted on key locations of the bearing plate 140. The detected forces represent the pressure applied to the formwork panels 111, 112 and form ties 120. As compressive force from the concrete is applied to the formwork assembly 110, strain gauges embedded within the sensors experience mechanical deformation. In addition to force data, the system 105 also measures environmental conditions, such as barometric pressure and temperature, using integrated sensors. These environmental values are periodically read and included in the transmitted data, providing a comprehensive overview of the system's 105 operational conditions.

At step 720, as the load-bearing surface 140a is subjected to compressive forces, both the compression sensor 160 and tension sensor 161 detect the resulting mechanical strain on the multi-faceted bearing plate 140. In embodiments, the detected strain is directly proportional to the magnitude of the applied compressive forces, providing an accurate measurement of the pressure exerted on the system 105. The mechanical deformation of the bearing plate 140 causes a change in electrical resistance within the strain gauges integrated into the sensors 160, 161. This change in resistance is proportional to the amount of strain, which in turn corresponds to the force being applied, allowing for precise force measurement through the strain gauge response.

At step 725, the strain data captured by the sensors 160 and 161 is converted into electrical signals. In embodiments, this data is routed through a Wheatstone bridge circuit integrated within the load cell 130. This configuration detects small changes in resistance caused by the applied strain, converting these changes into a differential voltage signal.

At step 730, if the generated electrical signal is small, a signal amplifier integrated into the signal processing unit 162 boosts the voltage to a readable level, ensuring that even small force changes can be accurately detected and processed. In embodiments, a precision amplifier is utilized, which boosts the signal to a level suitable for further processing. This amplified signal accurately represents the magnitude of the forces acting on the load-bearing surface 140a, ensuring reliable force measurement.

At step 735, the amplified signal is converted from an analog voltage into digital force data through the analog-to-digital converter 163. This conversion transforms the continuous analog signal into a digital format, enabling further processing and electronic storage. The digital output, while proportional to the applied force, may need to be calibrated and converted into meaningful force units, such as Newtons or pounds.

At step 740, the digital force data is processed by the control unit 164. This process, in embodiments, involves applying a calibration constant, established during the system's 105 initial calibration, to account for the specific characteristics of the load cell 130, such as its sensitivity in millivolts per volt per Newton. This ensures that the force data is both accurate and reflective of the actual conditions being measured.

At step 745, the processed force data is transmitted wirelessly via the wireless communication unit 165 to a remote user interface, enabling real-time monitoring of the formwork pressure. The system 105 supports multiple transmission protocols, including BLUETOOTH®, Wi-Fi, and in some embodiments, LTE, allowing for flexible communication with devices such as smartphones, wearable devices, computers, cloud-based servers, and more. This ensures that users can monitor data continuously during the concrete pour, facilitating quick decision-making. The system 105 is also capable of broadcasting data to external devices, which can access the transmitted information for real-time analysis.

The data, including force and other measurements and time-stamped pressure changes, may be packaged into wireless packets and sent to the user interface. In further embodiments, the data is also transmitted to cloud servers for archiving and further processing. The system 105 is designed to handle potential errors during sensor initialization or calibration by outputting diagnostic messages to the serial console, ensuring proper troubleshooting and system maintenance. This robust wireless communication ensures accurate, timely data transfer for optimal monitoring and control during concrete pours.

At step 750, the transmitted data is displayed in one or more formats, such as text or graphical representations, illustrating the real-time pressure distribution across the formwork panels 111 and 112. This allows operators to monitor the force exerted within the formwork assembly 110 in real-time, ensuring that the pressure remains within safe operational limits.

The user interface, which may be a mobile app, a web-based application, desktop software, or similar, receives the wireless data and provides real-time visualization of the pressure distribution from one or more load cells 130. Graphical representations show the force applied at various points of the formwork assembly 110, offering a clear view of where the pressure is concentrated. The system 105 continuously updates this display, allowing operators to observe fluctuations in force, and other parameters, during the concrete pour, facilitating informed decision-making to maintain structural integrity.

At step 755, if the force or pressure exceeds pre-set safety thresholds-such as regulatory limits or the rated capacity of critical components, for example, the form ties 120—the system 105 automatically triggers alerts to notify the operator. The system 105 is configured with threshold monitoring, where maximum allowable pressure limits are set for the formwork. These alerts can be visual, auditory, notifications on the user interface, on a display on the load cell 130, a combination of these, and more ensuring that any potential risks, such as formwork failure, are promptly identified and addressed. This real-time alert system is crucial for preventing structural damage and ensuring the safe continuation of the concrete pour.

At step 760, based on real-time data analysis, the system 105 may prompt the operator to adjust the pour rate if necessary, to ensure the applied pressure remains within safe limits, optimizing the integrity of the formwork during the concrete pour. Alternatively, if pressure is well within safe limits, prompt user to increase speed while staying in safe limits to increase efficiency.

At step 760, based on real-time data analysis, the system 105 may prompt the operator to adjust the concrete pour rate if necessary to ensure that the applied pressure remains within safe limits, thereby optimizing the structural integrity of the formwork during the pour. Alternatively, if the pressure remains well within the safe limits, the system 105 may prompt the operator to increase the pour rate while maintaining safety, thereby improving overall efficiency.

At step 770, all pressure and force data are stored for post-pour analysis, allowing for comprehensive review and optimization of future concrete pours. The system 105 archives pressure readings, timestamps, and event alerts in onboard memory or on a connected cloud service, ensuring that the data is accessible for quality control and structural assessments. The stored data may be utilized to analyze pressure distribution patterns, verify that the pour remained within safety parameters, and identify opportunities for improving the efficiency and safety of subsequent pours.

This process repeats continuously, allowing for real-time monitoring of both weight and environmental conditions. The system 105 is designed to be highly accurate, with provisions for calibration and tare adjustments, and is able to transmit data wirelessly for convenience and integration into broader systems. The system 105 ensures that data can be accessed from a variety of devices, enhancing its versatility in various applications.

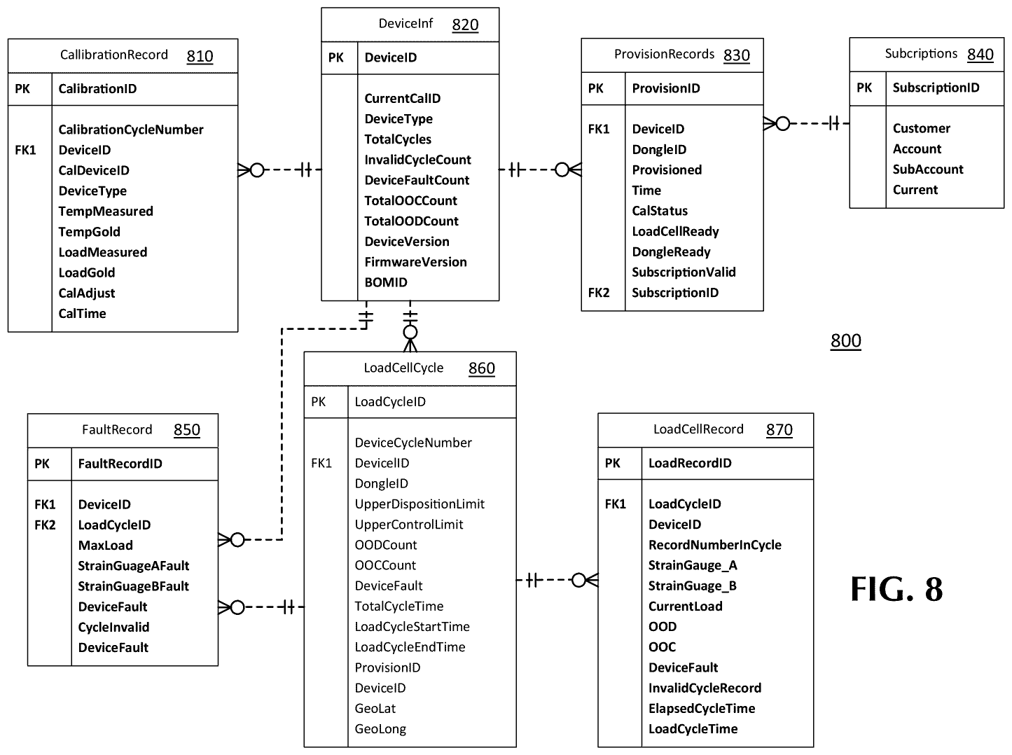

Referring to FIG. 8, an exemplary database topology for the form pressure concrete monitoring system, assembly, and apparatus is organized into several components. The database 800 stores all relevant system data necessary for operation, analysis, and troubleshooting. The calibration date 810 table holds information regarding calibration events, including timestamps and details about system recalibration processes to ensure accurate force measurements. The system information 820 table captures essential operational data such as device IDs, firmware versions, and system cycles, which allow real-time monitoring of system health and performance.

The system provision record 830 logs data related to the provisioning of system devices and components. This table includes timestamps for when devices were provisioned and the readiness status of components like the load cell and subscription validation. The service subscriptions 840 table manages the subscription status for users, tracking customer accounts, subaccounts, and the current status of service access, ensuring only authorized users can interact with the system. The error log 850 tracks system faults, including sensor errors and cycle issues, which are crucial for diagnosing problems and maintaining system performance.

The cell loading cycle 860 records the operational details of each load cycle, such as the start and end times, geographic location, and any limits encountered during the operation. The cell loading record 870 provides a detailed log of strain gauge data, force measurements, and time-based records for each cycle, which are essential for post-analysis of pressure distribution and overall system efficiency. This structured database design allows for real-time monitoring, detailed historical analysis, and optimized operation of the form pressure monitoring system.

The structural components system, including the load cell, work in conjunction with the system's functional modules to provide real-time data analysis and decision-making capabilities. The load cell, designed to measure compressive forces exerted by the concrete, transfers these physical pressures into electrical signals via the embedded compression and tension sensors. These signals are then transmitted to the processing unit, which interprets the data in the context of the ongoing concrete pour. The processing unit evaluates the pressure distribution in real time, comparing the data against pre-set safety thresholds, and sends actionable feedback to the user interface. This integration allows for immediate adjustments, such as altering the pour rate, thereby optimizing both the safety and efficiency of the concrete pouring process. By maintaining constant communication between the load cell's sensors and the processing unit, the system ensures that the structural integrity of the formwork is preserved while minimizing the risk of blowouts or structural failure.

The various embodiments of the system disclosed herein may incorporate advanced features designed to enhance functionality in challenging construction environments. One such feature is the LTE autosense multiband function, which maximizes signal strength in high signal-attenuating environments, such as those commonly encountered in concrete forming assemblies. This technology ensures consistent and reliable data transmission even in dense material surroundings, enabling continuous monitoring without signal degradation.

Machine learning (ML) models may be employed within the system to enable a smart reliquification warning notification system. This feature provides project managers with real-time alerts regarding potential concrete reliquification events, offering better control over heavy equipment operation and environmental factors that could otherwise destabilize the concrete. By incorporating ML algorithms, the system intelligently anticipates risks and issues warnings before a reliquification event occurs, optimizing the safety and efficiency of the construction process.

Additionally, the system may utilize artificial intelligence (AI) to assist in identifying the end of concrete pours, thereby eliminating the need for project managers to continuously monitor the site to determine when conditions are met for removing concrete forming. This AI-enabled end-of-pour detection ensures that removal occurs at the most optimal time, reducing human error and increasing operational efficiency.

For battery-operated components, the system may implement AI-assisted deep sleep and soft power-off rules, which maximize battery life by intelligently adjusting power usage based on real-time operational needs. This feature is critical for long-term monitoring, particularly on remote or hard-to-access construction sites where frequent battery replacement is impractical.

In certain embodiments, visual and auditory feedback may be provided to the users. For instance, the system could include bright, multi-color LED striping along the load cell body, providing real-time visual feedback on the force being applied to the material and alerting the user when the material is approaching maximum load limits. In addition, auditory alarms may be triggered when force-loading thresholds are breached, offering immediate warnings about critical load conditions.

The system may also be integrated with AI-assisted customized statistical process control (SPC) rules, which alert users to impending and actual violations of force-loading limits. By continually analyzing real-time data, the AI ensures that project managers are notified of potential risks before they become critical, thereby allowing for timely intervention and avoiding costly errors or structural failures.

Embodiments may further include proprietary BLUETOOTH® advertisement protocols to facilitate seamless multi-factor authentication (MFA) in the IoT edge environment. This location-based authentication system ensures secure access to the monitoring data and sensor networks while maintaining simplicity for users in the field. Additionally, GPS and cellular-assisted smart grouping of several load cells and sensors may be employed to intelligently cluster sensors based on geographic proximity and environmental conditions, allowing for optimized data collection and analysis for large-scale construction projects.

The system may feature a LoRa transceiver that integrates with project environment sensors, enabling long-range, attenuation-penetrating communication. This transceiver allows the system to send multiple sensor telemetry points to the IoT cloud, ensuring comprehensive monitoring even over vast construction sites. By leveraging overlapping LoRa network gateways, the system can fuse data from multiple sensors within the ecosystem, providing a robust and scalable solution for large, complex projects.

Further enhancing the system's communication capabilities, certain embodiments may feature BLE mesh networking, which dynamically creates a resilient BLUETOOTH® network by fusing sensor data with other ecosystem sensors. This feature allows for a flexible and self-healing network, ensuring that the system remains operational even when individual sensors or connections are compromised, further enhancing reliability in construction environments.

The various embodiments enclosed herein may utilize one or more of the features and capabilities described above, either alone or in combination, to enhance the functionality, reliability, and efficiency of the form pressure concrete monitor system in diverse construction environments. While the focus of the present disclosure is on concrete form applications, the system described herein has broad applicability across various industries. It is well-suited for industrial weighing, material testing, and other applications requiring precise force and weight measurement.

Put variously, the present disclosure includes a load cell that may incorporate transducers and/or sensors designed to convert mechanical forces into electrical signals, enabling precise measurement of force, weight, and pressure exerted by external elements, such as form ties. The sensing elements include highly sensitive components, such as strain gauges and/or piezoelectric crystals, for measuring force, along with optional temperature, humidity, and moisture sensors for assessing concrete curing conditions. When pressure is applied, these sensing elements undergo controlled deformation, resulting in measurable changes in electrical parameters, such as resistance or voltage, which provide an accurate indication of the magnitude and distribution of the compressive forces being applied. In embodiments, the load cell is designed and calibrated to withstand pressure in excess of 40,000 pounds.

In embodiments, to improve the accuracy of force measurements, the load cell houses an array of four sensors. Two sensors are positioned near the central opening, spaced 180 degrees apart, configured to measure compression. The other two sensors are located farther from the central opening, also spaced 180 degrees apart but rotated 90 degrees relative to the inner sensors, and are designed to measure tension. This arrangement enables the load cell to detect and analyze differential pressure between the two sets of sensors. In further embodiments, the sensors may be configured in a Wheatstone bridge circuit. When force is applied, the sensors, such as strain gauges, detect displacement of the load-receiving element, which causes changes in resistance. These resistance changes are proportional to the applied force and form the basis for measuring the load.

The upper housing of the load cell maintains a flat surface that facilitates consistent force distribution by utilizing a raised section around the central opening, which serves as the load-receiving element. This raised portion effectively transmits and concentrates the force onto the inner sensors, enabling precise pressure measurement and differential analysis.

To install the load cell, a user positions the load cell over a form tie that has been securely affixed to the formwork. The load cell is placed over the form tie using the central opening, a metal washer and a nut are placed over the load cell. The load cell, while mounted on the form tie, is not part of the formwork itself.

Another aspect of the disclosure is a data processing and transmission unit, which may be connected to the load cell via appropriate wiring or be formed as part of the load cell itself. The unit may include a custom-designed printed-circuit board (PCB) acting as the central hub, managing the system's functions, including interfacing with the load cell, processing data, and handling wireless connectivity. A dedicated data processing unit, which includes a microcontroller, memory, and specialized algorithms, may be utilized to collect raw data from the sensors and convert it into precise load measurements and pressure readings. A data storage unit with non-volatile memory stores historical records for future reference may also be included. The system may also include wireless communication modules such as near-field communication (NFC), BLUETOOTH®, Wi-Fi®, or mobile broadband networks. Adding a global positioning system (GPS) module can further enhance functionality by providing precise location tracking during concrete placement.

Users may input project-specific data to customize the monitoring process. This can include formwork size and dimensions, concrete type, ambient conditions, and more, ensuring that the monitoring parameters are tailored to each project. The system's interface allows users to input project data, access real-time readings, and take proactive steps to ensure successful concrete placement. If equipped with a GPS module, the system may also gather environmental information based on location. The system, in embodiments, analyzes historical data from past projects to provide predictive insights on factors such as curing time or pour speed, enabling users make informed decisions and optimize the timeline and quality of the project. Users may export data and generate reports detailing concrete pour parameters, environmental conditions, and other relevant metrics for quality control and regulatory compliance.

To use the system, the load cell is secured to the form tie, users initialized the load cell and related components, and using an external device track pressure build-up in real-time data. After the pour is completed, the load cell may be removed and stored for future use, with the collected data available for post-pour analysis and documentation.

Various embodiments of form pressure concrete monitor are configured to transmit data between two devices are described below and illustrated in the associated drawings. Unless otherwise specified, the form pressure concrete monitor and/or their various components may contain at least one of the structure, components, functionality, and/or variations described, illustrated, and/or incorporated herein. Furthermore, the structures, components, functionalities, and/or variations described, illustrated, and/or incorporated herein in connection with the present disclosure may be included in other similar monitor systems. The following description of various embodiments is merely illustrative in nature and is in no way intended to limit the disclosure, its application, or uses. Additionally, the advantages provided by the embodiments, as described below, are illustrative in nature and not all embodiments provide the same advantages or the same degree of advantages.

Aspects of form pressure concrete monitor may be embodied as a computer method, computer system, or computer program product. Accordingly, aspects of the form pressure concrete monitor may take the form of an entirely hardware embodiment, an entirely software embodiment (including firmware, resident software, micro-code, and the like), or an embodiment combining software and hardware aspects, all of which may generally be referred to herein as a “circuit,” “module,” or “system.” Furthermore, aspects of the form pressure concrete monitor may take the form of a computer program product embodied in a computer-readable medium (or media) having computer-readable program code/instructions embodied thereon.

Any combination of computer-readable media may be utilized. Computer-readable media can be a computer-readable signal medium and/or a computer-readable storage medium. A computer-readable storage medium may include an electronic, magnetic, optical, electromagnetic, IR, and/or semiconductor system, apparatus, or device, or any suitable combination of these. More specific examples of a computer-readable storage medium may include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, a solid-state drive, and/or any suitable combination of these and/or the like. In the context of this disclosure, a computer-readable storage medium may include any suitable tangible medium that can contain or store a program for use by or in connection with an instruction execution system, apparatus, or device.

A computer-readable signal medium may include a propagated data signal with computer-readable program code embodied therein, for example, in baseband or as part of a carrier wave. Such a propagated signal may take any of a variety of forms, including electro-magnetic, optical, audible, and/or any suitable combination thereof. A computer-readable signal medium may include any computer-readable medium that is not a computer-readable storage medium and that is capable of communicating, propagating, or transporting a program for use by or in connection with an instruction execution system, apparatus, or device.

Program code embodied on a computer-readable medium may be transmitted using any appropriate medium, including wireless, wireline, optical fiber cable, RF, and/or the like, and/or any suitable combination of these.

Computer program code for carrying out operations for aspects of the form pressure concrete monitor may be written in one or any combination of programming languages, including an object-oriented programming language such as Python, Java, Smalltalk, C++, C Sharp, Swift, and/or the like, and conventional procedural programming languages, such as the C programming languages. The program code may execute entirely on a user's computer, partly on the user's computer, as a stand-alone software package, partly on the user's computer and partly on a remote computer, or entirely on the remote computer or server. In the latter scenario, the remote computer may be connected to the user's computer through any type of network, including a local area network (LAN) or a wide area network (WAN), and/or the connection may be made to an external computer (for example, through the Internet using an Internet Service Provider).

Aspects of the form pressure concrete monitor are described below with reference to flowchart illustrations and/or block diagrams of methods, apparatuses, systems, and/or computer program products. Each block and/or combination of blocks in a flowchart and/or block diagram may be implemented by computer program instructions. The computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions also can be stored in a computer-readable medium that can direct a computer, other programmable data processing apparatus, and/or other device to function in a particular manner, such that the instructions stored in the computer-readable medium produce an article of manufacture including instructions which implement the function/act specified in the flowchart and/or block diagram block or blocks.

The computer program instructions also can be loaded onto a computer, other programmable data processing apparatus, and/or other device to cause a series of operational steps to be performed on the device to produce a computer-implemented process such that the instructions which execute on the computer or other programmable apparatus provide processes for implementing the functions/acts specified in the flowchart and/or block diagram block or blocks.

Any flowchart and/or block diagram in the drawings is intended to illustrate the architecture, functionality, and/or operation of possible implementations of systems, methods, and computer program products according to aspects of the form pressure concrete monitor. In this regard, each block may represent a module, segment, or portion of code, which comprises one or more executable instructions for implementing the specified logical function(s). In some implementations, the functions noted in the block may occur out of the order noted in the drawings. For example, two blocks shown in succession may, in fact, be executed substantially concurrently, or the blocks may sometimes be executed in the reverse order, depending upon the functionality involved. Each block and/or combination of blocks may be implemented by special purpose hardware-based systems (or combinations of special purpose hardware and computer instructions) that perform the specified functions or acts.

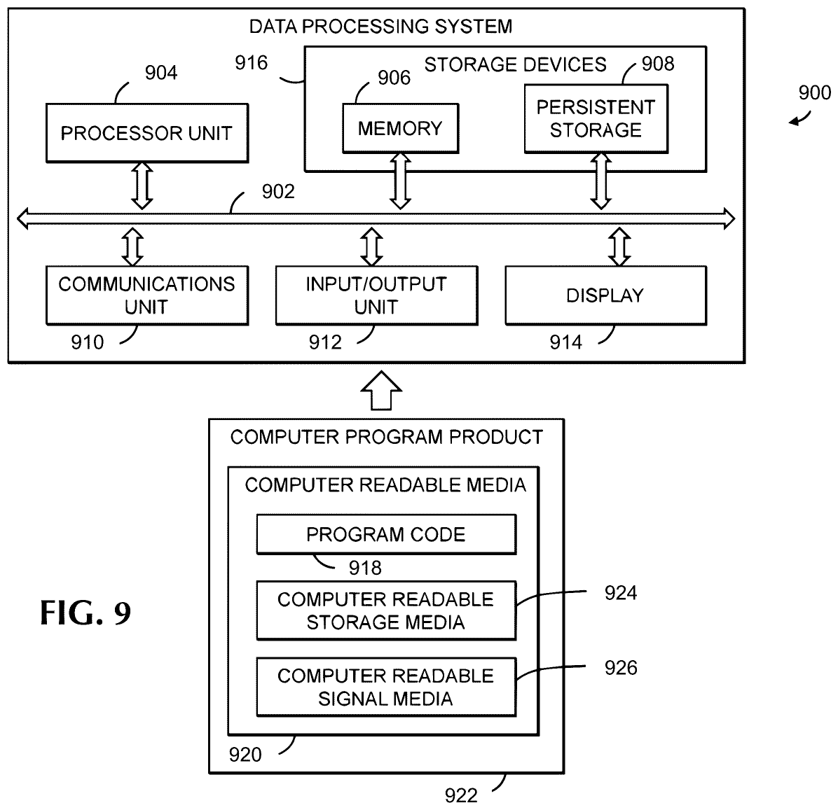

FIG. 9 shows, in accordance with aspects of the present disclosure, an example describing a data processing system 900. In this example, data processing system 900 is an illustrative data processing system suitable for implementing aspects of methods and systems of the form pressure concrete monitor. More specifically, in some examples, devices that are embodiments of data processing systems, e.g., smartphones, tablets, personal computers may be used by one or more users such as retailers, customers, advertisers, consumers, patients, healthcare providers, etc. Further, devices that are embodiments of data processing systems, e.g., smartphones, tablets, personal computers, may be used as one or more server(s) in encoding, decoding, and communicating signals with one or more mobile communication devices.

In this illustrative example, data processing system 900 includes communications framework 902. Communications framework 902 provides communications between processor unit 904, memory 906, persistent storage 908, communications unit 910, input/output (I/O) unit 912, and display 914. Memory 906, persistent storage 908, communications unit 910, input/output (I/O) unit 912, and display 914 are examples of resources accessible by processor unit 904 via communications framework 902.

Processor unit 904 serves to run instructions that may be loaded into memory 906. Processor unit 904 may be a number of processors, a multi-processor core, or some other type of processor, depending on the particular implementation. Further, processor unit 904 may be implemented using a number of heterogeneous processor systems in which a main processor is present with secondary processors on a single chip. As another illustrative example, processor unit 904 may be a symmetric multi-processor system containing multiple processors of the same type.

Memory 906 and persistent storage 908 are examples of storage devices 916. A storage device is any piece of hardware that is capable of storing information, such as, for example, without limitation, data, program code in functional form, and other suitable information either on a temporary basis or a permanent basis.

Storage devices 916 also may be referred to as computer-readable storage devices in these examples. Memory 906, in these examples, may be, for example, a random access memory or any other suitable volatile or non-volatile storage device. Persistent storage 908 may take various forms, depending on the particular implementation.

For example, persistent storage 908 may contain one or more components or devices. For example, persistent storage 908 may be a hard drive, a flash memory, a rewritable optical disk, a rewritable magnetic tape, or some combination of the above. The media used by persistent storage 908 also may be removable. For example, a removable hard drive may be used for persistent storage 908.

Communications unit 910, in these examples, provides for communications with other data processing systems or devices. In these examples, communications unit 910 is a network interface card. Communications unit 910 may provide communications through the use of either or both physical and wireless communications links.

Input/output (I/O) unit 912 allows for input and output of data with other devices that may be connected to data processing system 900. For example, input/output (I/O) unit 912 may provide a connection for user input through a keyboard, a mouse, and/or some other suitable input device. Further, input/output (I/O) unit 912 may send output to a printer. Display 914 provides a mechanism to display information to a user.

Instructions for the operating system, applications, and/or programs may be located in storage devices 916, which are in communication with processor unit 904 through communications framework 902. In these illustrative examples, the instructions are in a functional form on persistent storage 908. These instructions may be loaded into memory 906 for execution by processor unit 904. The processes of the different embodiments may be performed by processor unit 904 using computer-implemented instructions, which may be located in a memory, such as memory 906.

These instructions are referred to as program instructions, program code, computer usable program code, or computer-readable program code that may be read and executed by a processor in processor unit 904. The program code in the different embodiments may be embodied on different physical or computer-readable storage media, such as memory 906 or persistent storage 908.

Program code 918 is located in a functional form on computer-readable media 920 that is selectively removable and may be loaded onto or transferred to data processing system 900 for execution by processor unit 904. Program code 918 and computer-readable media 290 form computer program product 922 in these examples. In one example, computer-readable media 290 may be computer-readable storage media 924 or computer-readable signal media 926.

Computer-readable storage media 924 may include, for example, an optical or magnetic disk that is inserted or placed into a drive or other device that is part of persistent storage 908 for transfer onto a storage device, such as a hard drive, that is part of persistent storage 908. Computer-readable storage media 924 also may take the form of a persistent storage, such as a hard drive, a thumb drive, or a flash memory, that is connected to data processing system 900. In some instances, computer-readable storage media 924 may not be removable from data processing system 900.

In these examples, computer-readable storage media 924 is a physical or tangible storage device used to store program code 918 rather than a medium that propagates or transmits program code 918. Computer-readable storage media 924 is also referred to as a computer-readable tangible storage device or a computer-readable physical storage device. In other words, computer-readable storage media 924 is non-transitory.

Alternatively, program code 918 may be transferred to data processing system 900 using computer-readable signal media 926. Computer-readable signal media 926 may be, for example, a propagated data signal containing program code 918. For example, computer-readable signal media 926 may be an electromagnetic signal, an optical signal, and/or any other suitable type of signal. These signals may be transmitted over communications links, such as wireless communications links, optical fiber cable, coaxial cable, a wire, and/or any other suitable type of communications link. In other words, the communications link and/or the connection may be physical or wireless in the illustrative examples.

In some illustrative embodiments, program code 918 may be downloaded over a network to persistent storage 908 from another device or data processing system through computer-readable signal media 926 for use within data processing system 900. For instance, program code stored in a computer-readable storage medium in a server data processing system may be downloaded over a network from the server to data processing system 900. The data processing system providing program code 918 may be a server computer, a client computer, or some other device capable of storing and transmitting program code 918.

The different components illustrated for data processing system 900 are not meant to provide architectural limitations to the manner in which different embodiments may be implemented. The different illustrative embodiments may be implemented in a data processing system including components in addition to and/or in place of those illustrated for data processing system 900. Other components shown in FIG. 2 can be varied from the illustrative examples shown. The different embodiments may be implemented using any hardware device or system capable of running program code. As one example, data processing system 900 may include organic components integrated with inorganic components and/or may be comprised entirely of organic components excluding a human being. For example, a storage device may be comprised of an organic semiconductor.

In another illustrative example, processor unit 904 may take the form of a hardware unit that has circuits that are manufactured or configured for a particular use. This type of hardware may perform operations without needing program code to be loaded into a memory from a storage device to be configured to perform the operations.

For example, when processor unit 904 takes the form of a hardware unit, processor unit 904 may be a circuit system, an application specific integrated circuit (ASIC), a programmable logic device, or some other suitable type of hardware configured to perform a number of operations. With a programmable logic device, the device is configured to perform the number of operations. The device may be reconfigured at a later time or may be permanently configured to perform the number of operations. Examples of programmable logic devices include, for example, a programmable logic array, a field programmable logic array, a field programmable gate array, and other suitable hardware devices. With this type of implementation, program code 918 may be omitted, because the processes for the different embodiments are implemented in a hardware unit.

In still another illustrative example, processor unit 904 may be implemented using a combination of processors found in computers and hardware units. Processor unit 904 may have a number of hardware units and a number of processors that are configured to run program code 918. With this depicted example, some of the processes may be implemented in the number of hardware units, while other processes may be implemented in the number of processors.

In another example, a bus system may be used to implement communications framework 902 and may be comprised of one or more buses, such as a system bus or an input/output (I/O) bus. Of course, the bus system may be implemented using any suitable type of architecture that provides for a transfer of data between different components or devices attached to the bus system.

Additionally, communications unit 910 may include a number of devices that transmit data, receive data, or both transmit and receive data. Communications unit 910 may be, for example, a modem or a network adapter, two network adapters, or some combination thereof. Further, a memory may be, for example, memory 906, or a cache, such as that found in an interface and memory controller hub that may be present in communications framework 902.

The flowcharts and block diagrams described herein illustrate the architecture, functionality, and operation of possible implementations of systems, methods, and computer program products according to various illustrative embodiments. In this regard, each block in the flowcharts or block diagrams may represent a module, segment, or portion of code, which comprises one or more executable instructions for implementing the specified logical function or functions. It should also be noted that, in some alternative implementations, the functions noted in a block may occur out of the order noted in the drawings. For example, the functions of two blocks shown in succession may be executed substantially concurrently, or the functions of the blocks may sometimes be executed in the reverse order, depending upon the functionality involved.

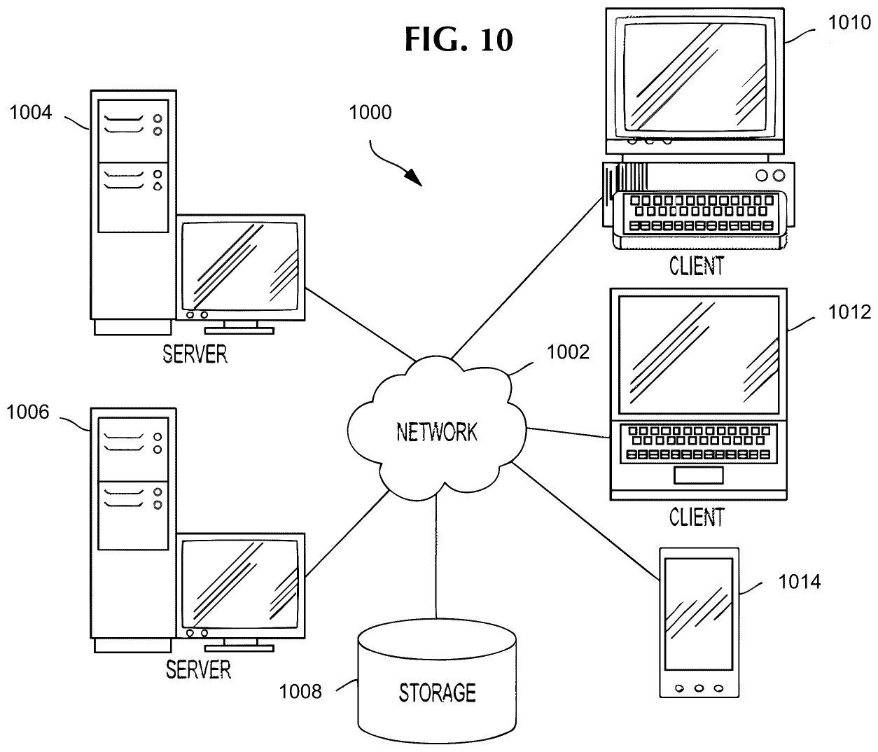

FIG. 10 shows an example describing a general network data processing system 1000, interchangeably termed a network, a computer network, a network system, or a distributed network, aspects of which may be included in one or more illustrative embodiments of methods and systems of the form pressure concrete monitor. For example, one or more mobile computing devices or data processing devices may communicate with one another or with one or more servers(s) through the network. It should be appreciated that FIG. 10 is provided as an illustration of one implementation and is not intended to imply any limitation with regard to environments in which different embodiments may be implemented. Many modifications to the depicted environment may be made.

Network data processing system 1000 is a network of computers, each of which is an example of data processing system 900, and other components. Network data processing system 1000 may include network 1002, which is a medium configured to provide communications links between various devices and computers connected together within network data processing system 1000. Network 1002 may include connections such as wired or wireless communication links, fiber optic cables, and/or any other suitable medium for transmitting and/or communicating data between network devices, or any combination thereof.

In the depicted example, a first network device 1004 and a second network device 1006 connect to network 1002, as does an electronic storage device 1008. Network devices 1004 and 1006 are each examples of data processing system 900, described above. In the depicted example, devices 1004 and 1006 are shown as server computers. However, network devices may include, without limitation, one or more personal computers, mobile computing devices such as personal digital assistants (PDAs), tablets, and smart phones, handheld gaming devices, wearable devices, tablet computers, routers, switches, voice gates, servers, electronic storage devices, imaging devices, and/or other networked-enabled tools that may perform a mechanical or other function. These network devices may be interconnected through wired, wireless, optical, and other appropriate communication links.

In addition, client electronic devices, such as a client computer 1100, a client laptop or tablet 1102, and/or a client smart device 1104, may connect to network 1002. Each of these devices is an example of data processing system 200, described above regarding FIG. 9. Client electronic devices 1100, 1102, and 1104 may include, for example, one or more personal computers, network computers, and/or mobile computing devices such as personal digital assistants (PDAs), smart phones, handheld gaming devices, wearable devices, and/or tablet computers, and the like. In the depicted example, server 1004 provides information, such as boot files, operating system images, and applications to one or more of client electronic devices 1100, 1102, and 1104. Client electronic devices 1100, 1102, and 1104 may be referred to as “clients” with respect to a server such as server computer 1004. Network data processing system 1000 may include more or fewer servers and clients or no servers or clients, as well as other devices not shown.

Client smart device 1104 may include any suitable portable electronic device capable of wireless communications and execution of software, such as a smartphone or a tablet. Generally speaking, the term “smartphone” may describe any suitable portable electronic device having more advanced computing ability and network connectivity than a typical mobile phone. In addition to making phone calls (e.g., over a cellular network), smartphones may be capable of sending and receiving emails, texts, and multimedia messages, accessing the Internet, and/or functioning as a web browser. Smartdevices (e.g., smartphones) may also include features of other known electronic devices, such as a media player, personal digital assistant, digital camera, video camera, and/or global positioning system. Smartdevices (e.g., smartphones) may be capable of connecting with other smartdevices, computers, or electronic devices wirelessly, such as through near field communications (NFC), BLUETOOTH®, Wi-Fi, or mobile broadband networks. Wireless connectivity may be established among smartdevices, smartphones, computers, and other devices to form a mobile network where information can be exchanged.

Program code located in system 1000 may be stored in or on a computer recordable storage medium, such as persistent storage 1008 in FIG. 10, and may be downloaded to a data processing system or other device for use. For example, program code may be stored on a computer recordable storage medium on server computer 1004 and downloaded for use to client 1100 over network 1002 for use on client 1100.

Network data processing system 1000 may be implemented as one or more of a number of different types of networks. For example, system 1000 may include an intranet, a local area network (LAN), a wide area network (WAN), or a personal area network (PAN). In some examples, network data processing system 1000 includes the Internet, with network 1002 representing a worldwide collection of networks and gateways that use the transmission control protocol/Internet protocol (TCP/IP) suite of protocols to communicate with one another. At the heart of the Internet is a backbone of high-speed data communication lines between major nodes or host computers. Thousands of commercial, governmental, educational and other computer systems may be utilized to route data and messages. FIG. 10 is intended as an example, and not as an architectural limitation for any illustrative embodiments.

It will be appreciated that the invention is not restricted to the particular embodiment that has been described, and that variations may be made therein without departing from the scope of the invention as defined in the appended claims, as interpreted in accordance with principles of prevailing law, including the doctrine of equivalents or any other principle that enlarges the enforceable scope of a claim beyond its literal scope. Unless the context indicates otherwise, a reference in a claim to the number of instances of an element, be it a reference to one instance or more than one instance, requires at least the stated number of instances of the element but is not intended to exclude from the scope of the claim a structure or method having more instances of that element than stated. The word “comprise” or a derivative thereof, when used in a claim, is used in a nonexclusive sense that is not intended to exclude the presence of other elements or steps in a claimed structure or method.

The invention claimed is:

1. A concrete form pressure monitoring system, comprising:
a) a load cell assembly configured to detect forces exerted on a formwork, said assembly comprising one or more pressure sensors, wherein said pressure sensors are configured to detect changes in pressure on said formwork; and
b) a processor operatively connected to said load cell assembly, said processor configured to:
i) receive one or more outputs from said assembly,
ii) analyze said outputs to determine said exerted forces on said formwork;
iii) compare said determined forces to a predefined threshold;
iv) generate a signal based on said determined forces and said predefined threshold; and
v) transmit said analyzed outputs and said signal to a device.

2. The system of claim 1, wherein said load cell assembly comprises at least two compression sensors and at least two tension sensors.

3. The system of claim 2, wherein said load cell assembly is attached to a form tie of said formwork, said form tie being capable of transferring both compression and tension forces from said formwork to said load cell assembly, wherein said predefined threshold is set based on the rated capacity of said form tie.

4. The system of claim 1, wherein said load cell assembly further comprises an integrated temperature sensor, configured to monitor environmental conditions within said assembly, wherein said conditions affect the curing rate of the concrete.

5. The system of claim 1, wherein:
said load cell assembly further comprises a temperature sensor, wherein said temperature sensor is configured to monitor environmental conditions within said assembly including temperature-induced pressure changes; and
said processor is further configured to offset determined forces based on said environmental conditions from said temperature sensor.

6. The system of claim 1, wherein said processor is configured to:
receive data from one or more environmental sensors located in proximity to said formwork, including temperature and humidity sensors, and
offset determined forces based on said data from said environmental sensors.

7. The system of claim 1, wherein said processor is further configured to:
control the concrete pouring rate, wherein said control automatically reduces said pouring rate when said forces approach said predefined threshold, or automatically increases said pouring rate when said forces are below a specified margin from said threshold; or
continuously adjust said pouring rate in a feedback loop, wherein said pouring rate is increased or decreased iteratively until said exerted forces on said formwork reach a target range relative to said threshold, and wherein said adjustments cease once said target range is met; or
trigger an indicator to notify an operator to adjust the concrete pouring rate, wherein said indicator is configured to prompt said operator to reduce said pouring rate when said determined forces approach said predefined threshold, or increase said pouring rate when said forces remain below a specified margin from said threshold.

8. The system of claim 1, wherein said processor is further configured to:
store said analyzed outputs and said signals; and
utilize said stored outputs and said stored signals to forecast future patterns based on historical data from previous concrete pours.

9. The system of claim 8, wherein said processor is further configured to adjust said determined forces based on previously stored outputs and signals from past concrete pours under similar conditions.

10. The system of claim 1, further comprising:
a sensor network including two or more of said load cell assemblies, wherein each of said load cell assembly is configured to detect one forces exerted on a respective region of said formwork; and
wherein said processor is operatively connected to said sensor network, said processor is further configured to:
i) receive one or more outputs from each said load cell assembly;
ii) determine from said outputs said forces exerted on said formwork at each of said respective region of each said load cell assembly;
iii) compare said determined forces to one or more predefined thresholds, wherein each said respective region of said formwork has one or more said thresholds specific to said respective region; and
iv) generate one or more signals based on said determined forces at said respective region of said load cell assembly and said predefined thresholds.

11. A method for monitoring concrete form pressure, comprising:
a) detecting one or more forces exerted on a formwork using a load cell assembly, wherein assembly including a pressure sensor, wherein said pressure sensor is configured to detect changes in pressure on said formwork;
b) receiving one or more outputs from said assembly,
c) determining from said outputs said forces on said formwork by a processor, wherein said processor is operatively connected to said assembly;
d) comparing, by said processor, said forces to a predefined threshold;
e) generating, by said processor, a signal based on said forces and said threshold; and
f) transmitting, by said processor, said forces and said signal to a device.

12. The method of claim 11, wherein said assembly including at least one two compression sensors and at least two tension sensors.

13. The method of claim 11, further comprising detecting temperature and humidity conditions within or near said formwork, wherein said processor is further configured to adjust said determined forces based on said environmental conditions to account for temperature-induced pressure changes.

14. The method of claim 11, further comprising the step of generating an alert signal, wherein said signal prompts an operator to adjust the concrete pouring rate, said signal prompting said operator to reduce said pouring rate when said forces approach said predefined threshold or increase said pouring rate when said forces are within a safe margin from said threshold.

15. The method of claim 11, further comprising:
analyzing said received data using machine-learning algorithms, wherein said processor is configured to identify risks based on real-time force data and historical data; and
adjusting said determined forces and said signal based on said analysis.

16. A concrete form pressure monitoring system, comprising:
a) a load cell assembly configured to detect forces exerted on a formwork, said assembly comprising one or more pressure sensors, wherein said pressure sensors are configured to detect changes in pressure on said formwork;
b) an accelerometer, wherein said accelerometer is configured to detect external vibrations; and
c) a processor operatively connected to said load cell assembly and to said accelerometer, wherein said processor is configured to:
d) receive one or more outputs from said load cell assembly and vibration data from said accelerometer;
e) analyze said outputs to determine exerted forces on said formwork and said vibration data to identify one or more vibration events affecting pressure on said formwork;
f) adjust said determined forces exerted on said formwork based on said identified vibration events;
g) compare said adjusted forces to a predefined threshold; and
h) generate one or more signals indicating one or more occurrences of said vibration events and whether said adjusted forces are within a specified range of said predefined threshold.

17. The system of claim 16, wherein said processor is further configured to transmit said analyzed outputs, said adjusted forces, said identified vibration events, and said signals to a device.

18. The system of claim 16, wherein said processor is configured to filter out low-magnitude vibrations from said vibration data.

19. The system of claim 16, wherein said load cell assembly further comprises a temperature sensor configured to monitor environmental conditions, and said processor is further configured to adjust said determined forces based on changes in temperature.

20. The system of claim 16, said accelerometer is further configured to detect vibrations using one or more of the following:
a) a device inserted into fresh plastic concrete;
b) external vibrators mounted to the exterior of the formwork; and
c) equipment in proximity to said formwork.
